(19) United States
(12) Patent Application Publication
(10) Pub. No.: US 2005/0191558 A1
(43) Pub. Date: Sep. 1, 2005

(54) Lithium cell battery

(76) Inventors: Lucas Sannier, Amiens (FR); Sylvie Grugeon, Feuquieres (FR); Stephane Lascaud, Fontainebleau (FR); Jean-Marie Tarascon, Amiens (FR)

Correspondence Address: MCCRACKEN & FRANK LLP, 200 W. ADAMS STREET, SUITE 2150, CHICAGO, IL, 60606, US

(21) Appl. No.: 10/517,875

(22) PCT Filed: Jun. 16, 2003
(86) PCT No.: PCT/FR03/01818

§ 371 Date: Dec. 13, 2004

(30) Foreign Application Priority Data
Jun. 17, 2002 (FR) 02/07433

(51) Int. Cl. H01M 10/40; H01M 2/16; H01M 10/04

(52) U.S. Cl. 429/303; 429/254; 29/623.5

(57) ABSTRACT

The invention concerns an electrochemical lithium cell battery (10; 12; 14) comprising at least one positive electrode (5, 6), at least one liquid electrolyte including at least one lithium salt, and at least one negative electrode (1, 2) Said cell battery (10; 12; 14) is characterized in that it comprises at least one layer (3, 13) of a gelled separator (SG) comprising at least one polymer (PG), capable of being gelled by the liquid electrolyte, which is at least partly gelled by the liquid electrolyte, in contact with the negative electrode (1, 2), and in that it comprises at least a layer (4) of a plasticized separator (SP), including at least one polymer (PP) capable of being plasticized by the liquid electrolyte, at least partly in contact with the separator layer (SG). The invention is particularly applicable to hybrid and/or electric vehicles or portable appliances.

The invention relates to a lithium electrochemical cell battery comprising at least one positive electrode (or cathode), at least one liquid electrolyte comprising at least one lithium salt, and at least one negative electrode (or anode). The invention also relates to the process for manufacturing such a battery and to the use thereof.

The extraordinary growth of the market for portable electronic equipment has generated, upstream, greater and greater competitiveness in the field of rechargeable batteries or cells. Apart from mobile telephones, which have undergone extremely rapid development, the sales of portable computers, growing at 20% per year, entail new requirements as regards the performance of their power supplies. To this should also be added the expansion of the market for camcorders, digital cameras, portable CD players, wireless devices and numerous toys that more and more often require rechargeable batteries. Finally, it is probable that the 21st century will experience a considerable growth in electric vehicles, the emergence of which will result from the increasingly strict international regulations as regards toxic emissions by internal combustion engines.

Although the battery market is presently a very attractive one, it is however important to make the right choice so as to be able to position ourselves for the new generation of electronic devices. In fact, it is the progress made in electronics that dictates the specification for tomorrow's batteries. Added to the demand for more self-sufficient batteries has, in recent years, owing to miniaturization, the desire to have thinner and more flexible batteries. Dry polymer technology and Li-ion polymer technology may provide this flexibility. However, the first technology can operate only at temperatures above 60° C. and therefore is inappropriate for portable applications. As regard the second technology, this is currently penetrating the portable market at the expense, at the very least, of a loss of energy associated with the use of carbon rather than lithium.

Lithium ion batteries use gelled high-strength membranes based on fluoropolymers, for example PVDF (polyvinylidene fluoride), which are however, incompatible with Li metal (dimerization reaction at the interface). However, in addition to dendrite problems, other technological barriers regarding the compatibility of the polymers with Li metal remain to be raised. Specifically, dry polymer technology uses PEO (polyethylene oxide) and the gelling of this polymer, although possible, results in a membrane that adheres well to Li but is of low mechanical strength and consequently not easy to manufacture. To alleviate these difficulties, it has been envisaged to blend together two polymers, PEO and PVDF-HFP ((polyvinylidene fluoride)-co-(hexafluoropropylene)) so as to combine adhesion and mechanical strength properties. Thus, patent U.S. Pat. No. 6,165,645 describes a gelled electrolyte for a lithium polymer battery, which comprises a polymer alloy and an organic electrolyte solution. Such an alloy comprises a polymer that is difficult to dissolve in the electrolyte solution, for example PVDF, and another polymer that is soluble in said solution, for example PEO. However, the battery using the technology as described in patent U.S. Pat. No. 6,165,645 suffers from cyclability problems associated with the formation of lithium dendrites.

The inventors have found that, thanks to the battery according to the invention, it is possible to optimize the use of a layer of plasticized separator, called PS, comprising at least one plasticizable polymer, called PP, slightly solvated by the liquid electrolyte, and of a layer of a gelled separator, called GS, comprising at least one gellable polymer, called GP, which is predominantly gelled by the liquid electrolyte.

According to the invention, the term “plasticizable polymer” is understood to mean a polymer which can be plasticized by contacting it with the liquid electrolyte, that is to say it has a low affinity for the liquid electrolyte. According to the invention, the term “plasticized separator layer” is understood to mean a layer of a separator comprising predominantly at least one plasticized polymer. Such a layer is generally such that the mechanical strength of the layer of plasticizable polymer is maintained after being contacted with the liquid electrolyte, that is to say after the layer of plasticized polymer has been formed.

According to the invention, the term “gellable polymer” is understood to mean a polymer which can be gelled by contacting it with the liquid electrolyte, that is to say which has a high affinity for the liquid electrolyte. According to the invention, the term “layer of gelled separator” is understood to mean a layer of a separator comprising predominantly at least one gelled polymer. Such a layer is in general such that the mechanical strength of the layer of gellable polymer is lost after coming into contact with the liquid electrolyte, that is to say after the gel, namely the gelled polymer, has been formed.

The battery according to the invention is a lithium electrochemical cell battery comprising at least one positive electrode (or cathode), at least one liquid electrolyte comprising at least one lithium salt, and at least one negative electrode (or anode), said battery being characterized in that it comprises at least one layer of a gelled separator GS comprising at least one polymer GP, able to be gelled by the liquid electrolyte, which is at least partly, preferably almost completely gelled by the liquid electrolyte, in contact with the negative electrode, and in that it includes at least one layer of a plasticized separator PS comprising at least one polymer PP, able to be plasticized by the liquid electrolyte, which is at least partly, preferably almost completely, plasticized by the liquid electrolyte and at least partly, preferably almost completely, in contact with the layer of separator GS.

The battery according to the invention thus comprises at least one alternation of a positive electrode, a separator and a negative electrode, or cell. According to the invention, the battery may comprise several of these alternations or cells.

Advantageously, the contact between the negative electrode and the separator GS layer ensures adhesion, thanks to the physical properties of the “glue” which the polymer GP gelled by the liquid electrolyte forms, and also ensures a high-quality interface. In addition, the presence of the polymer PP ensures mechanical strength of the separator PS. According to the invention, the term “separator” is understood to mean a physical means for separating the two electrodes, that is to say a physical means that prevents any contact between the negative electrode and the positive electrode, while still allowing the ionic species necessary for the operation of the battery to pass through it.

According to one embodiment of the invention, the separator PS layer is at least partly, preferably almost completely, in contact with the positive electrode. In such a case, the separator is referred to as a bilayer separator. Thus, in this case, said battery preferably comprises, from the positive electrode to the negative electrode, a double layer consisting of a separator PS layer and a Separator GS layer.

According to another embodiment of the invention, battery comprises, in addition, another separator GS layer, called GSₐ, at least partly, and preferably almost completely, between the positive electrode and the separator PS layer. To simplify matters, when reference is made in the rest of the text to the properties or the nature of the Separator GS layer, the same also applies of course to the separator GSₐ layer. In such a case, the separator is referred to as a three-layer separator. Thus, in this case, said battery preferably comprises, from the positive electrode to the negative electrode, a triple layer consisting of a GSₐ separator layer, a separator PS layer and a separator GS layer.

The polymer PP is chosen from the group formed by polyvinylidene fluoride PVDF, polystyrene PS, polyvinyl chloride PVC, polycarbonate PC, ethylene-propylene-diene monomer EPDM, and derivatives thereof. The term “derivatives” is understood to mean any crosslinked polymer or copolymer obtained from one of these polymers. Preferably, the polymer PP is chosen from a group formed by polyvinylidene fluoride PVDF and (polyvinylidene fluoride)-co-(hexafluoropropylene) PVDF-HFP copolymers generally comprising from 0 (exclusive) to 30 mol %, preferably from 4 to 12 mol %, of HFP. Even more preferably, the polymer PP is PVDF-HFP copolymer generally comprising from 0 (exclusive) to 30 mol %, preferably from 4 to 12 mol %.

The polymer GP is generally chosen from the group formed by polymethyl methacrylate PMMA, polyethylene oxide PEO and polyacrylonitrile PAN, and derivatives thereof such as, for example, crosslinked polyethylene oxide copolymers generally comprising at least one unit chosen from the group formed by epichlorhydrin units, propylene oxide units and allyl glycidyl ether units. Preferably, the polymer GP is PEO.

The positive electrode preferably comprises carbon, active material, polymer PP and optionally at least one plasticizer. The term “plasticizer” is understood to mean an organic liquid or an oligomer having a low affinity for a polymer PP. Such a plasticizer thus makes it possible to create, within the polymer PP, pores that the plasticizer had occupied. Preferably, such pores may be freed by passing the material through a bath of a nonsolvent for the polymer PP, or by any other method known to those skilled in the art for extracting plasticizer without modifying the structure of the polymer PP. Advantageously, during the operation of the lithium battery, such pores are occupied by liquid electrolyte, which participates in the electro-chemical reactions at the positive electrode.

More generally, the positive electrode may comprise at least one transition metal oxide (a transition metal being an element of one of the groups of the Periodic Table of the Elements) capable of reversibly inserting and extracting lithium, for example an oxide chosen from the group formed by LiCoO₂, LiNiO₂, LiMn₂O₄, LiV₃O₈, V₂O₅, V₆O₁₃, LiFePO₄ and LiₓMnO₂ (0<x<0.5). In general, the positive electrode also includes a current collector, for example made of aluminum.

The negative electrode is preferably based on lithium metal, that is to say it mainly comprises lithium metal. However, more generally, the negative electrode may comprise metallic lithium, a lithium alloy and carbon or an inorganic compound capable of reversibly inserting and extracting lithium. The negative electrode may also include a current collector, for example made of copper.

The liquid electrolyte generally comprises at least one lithium salt such as, for example, the salts chosen from the group formed by LiCF₃SO₃, LiClO₄, LiN(C₂F₅SO₂)₂, LiN(CF₃SO₂)₂, LiAsF₆, LiPF₆, and LiBF₄.

The plasticizer optionally present is generally chosen from the group formed by PEO oligomers, dibutyl phthalate (DBP) and propylene carbonate (PC).

The invention also relates to a process for manufacturing a lithium electrochemical cell battery comprising at least one positive electrode (or cathode), at least one liquid electrolyte comprising at least one lithium salt, and at least one negative electrode (or anode) comprising an assembly of at least one layer of gelled separator GS, comprising at least one polymer GP, able to be gelled by the liquid electrolyte, on the negative electrode, of at least one layer of plasticized separator PS, comprising at least one polymer PP, able to be plasticized by the liquid electrolyte, on said separator GS layer, and optionally of at least one other layer of gelled separator GS, called GSₐ, comprising at least one polymer GP, on said separator PS layer, the combination of these two or three layers constituting a separator between the negative electrode and the positive electrode, an assembly of said separator on the positive electrode, and an impregnation of said separator by the liquid electrolyte.

In one method of implementing the process according to the invention, the positive electrode is generally manufactured in solution from polymer PP, carbon, active material, plasticizer and solvent.

In another method of implementing the process according to the invention, the positive electrode is generally manufactured by extrusion from polymer PP, carbon, active material and plasticizer.

In another method of implementing the process according to the invention, the separator PS layer is generally manufactured in solution from polymer PP, plasticizer and solvent.

In another method of implementing the process according to the invention, the separator PS layer is generally manufactured by extrusion from polymer PP, plasticizer or liquid electrolyte.

In another method of implementing the process according to the invention, the separator GS layer is generally manufactured in solution from polymer GP, solvent and optionally plasticizer.

In another method of implementing the process according to the invention, the separator GS layer is generally manufactured by extrusion from polymer GP, solvent and optionally plasticizer or liquid electrolyte.

Preferably, the polymer PP is generally filled with at least one mineral compound chosen, for example, from the group formed by MgO, SiO₂, Al₂O₃, TiO₂, BaTiO₃ and lithium salts such as LiAlO₂ and LiI.

Preferably, the polymer GP is generally filled with at least one mineral compound chosen, for example, from the group formed by MgO, SiO₂, Al₂O₃, TiO₂, BaTiO₃ and lithium salts such as LiAlO₂ and LiI.

In one method of implementation, the two or three PS and GS layers are joined together into a separator by hot lamination or hot calendering. The term “lamination” is understood to mean passing the layers between two rolls, the gap between which is kept constant. The term “calendering” is understood to mean passing the layers between two rolls, the pressure applied by the two rolls being constant. The expression “hot lamination or hot calendering” is understood to mean an operation carried out at a temperature generally between 50 and 140° C. for example about 130° C. The pressure exerted by the rolls is generally between about 5 psi and about 30 psi, that is to say between about 0.035 MPa and about 0.21 MPa, for example about 20 psi (i.e. about 0.14 MPa).

In another method of preparation, said layers form a three-layer separator obtained by passing the separator PS layer into a solution of polymer GP, or into a solution of liquid electrolyte in which the polymer GP has been dissolved.

In another method of preparation, said layers form a bilayer separator obtained by passing a separator PS layer, preassembled with the positive electrode, into a solution of polymer GP or into a solution of liquid electrolyte in which the polymer GP has been dissolved.

The positive electrode and the separator are generally joined together by hot lamination or hot calendering in order to form a plastic complex.

In addition, the plasticizer(s) optionally present in the positive electrode separator assembly is (are) removed by washing or vacuum extraction so as to obtain an assembly containing virtually no plasticizer.

The separator/positive electrode assembly, preferably containing virtually no plasticizer, is generally brought into contact with the negative electrode by a lamination or calendering step optionally carried out hot.

The polymer PP, the polymer GP, the positive electrode, the negative electrode, the liquid electrolyte and the plasticizer are, within the context of the process according to the invention, generally chosen in the same way as explained above in the case of the battery according to the invention.

Finally, the invention relates to the use of a battery as described above or manufactured according to the process as described above for a hybrid vehicle, an electric vehicle, for a stationary application (i.e. emergency power supply provided by a battery in the case of a breakdown of the electrical mains) or portable equipment application.

The invention will be more clearly understood and other features and advantages will become apparent on reading the following description, which is given by way of nonlimiting example and with reference to FIGS. 1 to 7.

FIG. 1 shows a schematic cross section through a battery having a bilayer separator according to the invention.

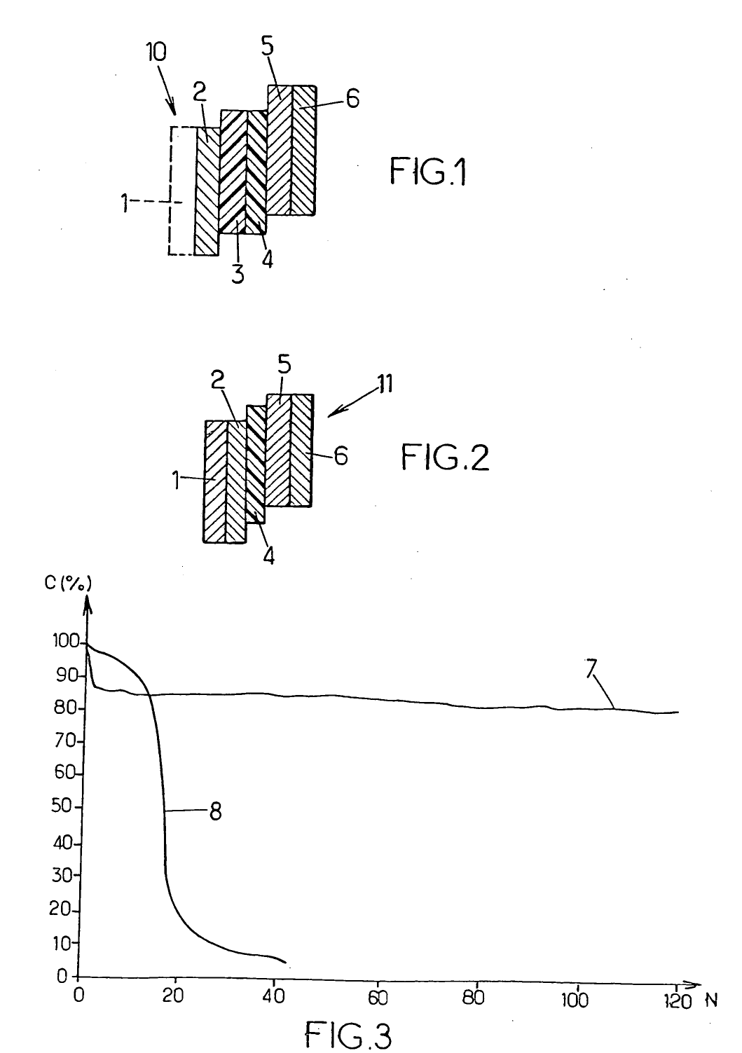

FIG. 2 shows a schematic cross section through a comparative battery according to the prior art.

FIG. 3 shows the percentage recovered capacity (C in %) as a function of the number of cycles (N) for the battery according to the invention of FIG. 1 and for the battery according to the prior art of FIG. 2, under slow cycling.

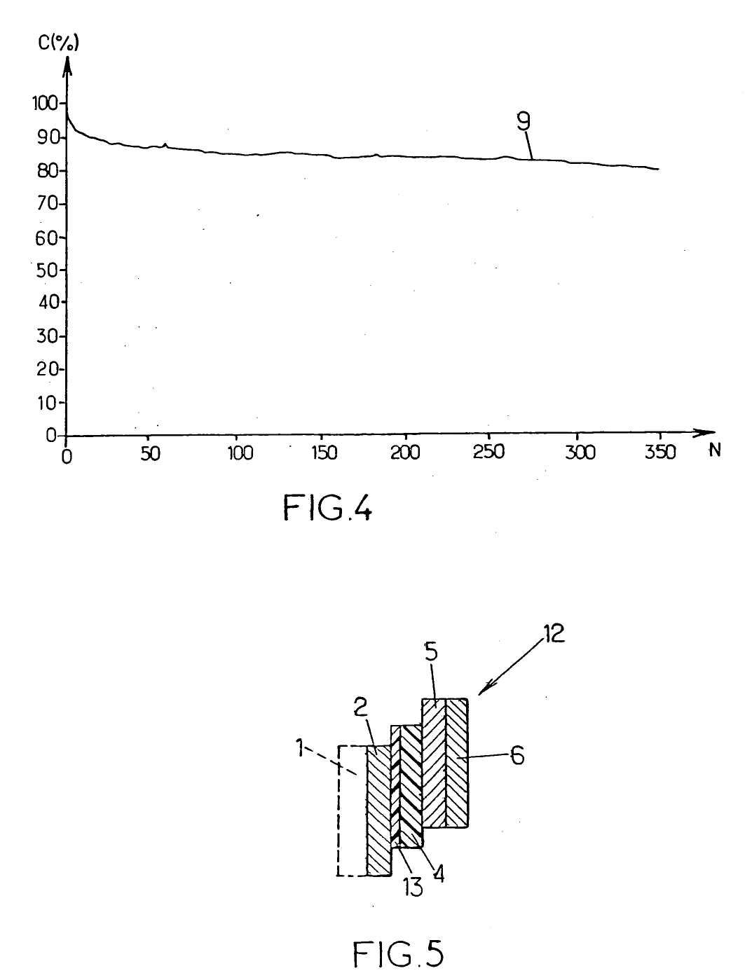

FIG. 4 shows the percentage recovered capacity (C in %) as a function of the number of cycles (N) for the battery according to the invention of FIG. 1, under rapid cycling.

FIG. 5 shows a schematic cross section through a battery according to the invention.

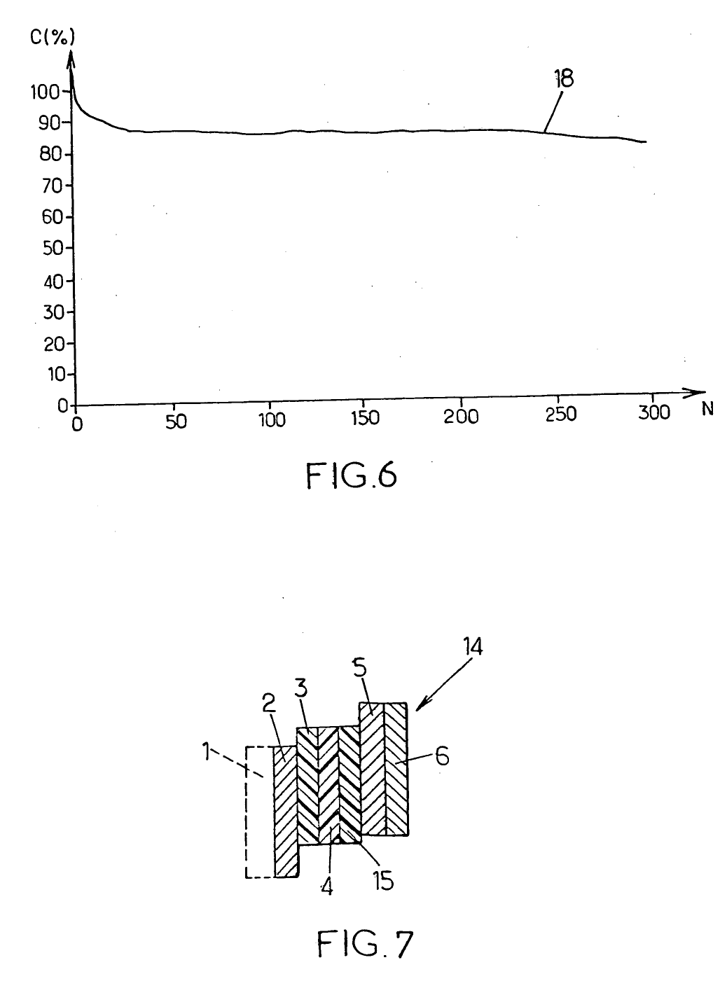

FIG. 6 shows the percentage recovered capacity (C in %) as a function of the number of cycles (N) for a battery according to the invention of FIG. 5.

FIG. 7 shows a schematic cross section through a battery having a three-layer separator according to the invention.

FIG. 1 shows a schematic cross section through a battery 10 having a bilayer separator (3, 4) according to the invention. The battery 10 comprises the negative electrode collector 1, for example made of copper, a negative electrode 2 (the active part) which is, for example, a layer of Li metal, a layer 3 consisting for example of a PEO layer, a layer 4 consisting for example of a layer of PVDF-HFP containing 12 mol % HFP, a layer 5 (the active part of the positive electrode) and a positive electrode current collector 6, for example made of aluminum. The presence of the collector 1 is not essential—this is why collector 1 has been shown in dotted lines.

FIG. 2 shows a schematic section through a comparative battery 11 according to the prior art, which comprises all the elements of FIG. 1 in the case when a connector 1 is present, except for the layer 3.

FIG. 3 will be commented upon below in Example 1.

FIG. 4 will be commented upon below in Example 2.

FIG. 5 is a schematic cross section through a battery 12 having a bilayer separator (13, 14) according to the invention, which comprises all the elements of FIG. 1 with the exception of the layer 3. Instead of the layer 3 there is a layer 13 that consists, for example, of a PEO gel layer, spread for example with a brush over the layer 4 during manufacture of the battery 12.

FIG. 6 will be commented upon below in Example 4.

FIG. 7 shows a schematic cross section through a battery 14 having a three-layer separator (3, 4, 15) according to the invention, the battery 14 comprises all the elements of FIG. 1, to which has been added a later 15, for example made of PEO, between the layer 4 and the layer 5.

### EXAMPLES

The examples below illustrate the invention without in any way limiting its scope.

### Process for Manufacturing the Battery According to the Invention of Examples 1 and 2

The manufacturing process described below relates to the manufacture of a single-cell battery 10, that is to say a battery consisting of a single succession of a negative electrode (5, 6), a positive electrode (1, 2) and a bilayer separator (3, 4) consisting of a layer 3 of polymer GP, which is for example PEO gelled by liquid electrolyte, and of a layer 4 of plasticized polymer, which is for example PVDF-HFP, the layer 3 being placed between the negative electrode (1, 2) and the layer 4, and the layer 4 being placed between the positive electrode (5, 6) and the layer 3. In the case described in Examples 1 to 4, the negative electrode (1, 2) comprises lithium metal 2, optionally with a copper collector 1. The positive electrode (5, 6) comprises an aluminum current collector 6 and a layer 5 of active material.

The PEO layer 3 is manufactured from a PEO/acetonitrile mixture, the acetonitrile being left to evaporate for several hours on a glass plate or on a sheet of Mylar®. Typically it has a thickness of 15 um. The PVDF-HFP layer 4 is obtained using a technology that consists in spreading, onto a Mylar® support, using a device of the doctor-blade type, a solution comprising PVDF-HFP, DBP (dibutyl phthalate), SiO₂ and acetone. A plastic layer for the positive electrode is obtained by spreading a solution comprising PVDF-HFP, DBP, active material (LiV₃O₈) and carbon in weight ratio of 10:1. Assembly of the cell comprises firstly thermal bonding of the plastic positive electrode 5 to the aluminum current collector 6 by hot calendering at a temperature close to 135° C. and at a pressure of about 20 psi (i.e. about 0.14 MPa). The resulting assembly is then bonded hot lamination, at a temperature close to 130° C. and at a pressure of about 20 psi (i.e. about 0.14 MPa), to the two layers 3 and 4 of the bilayer separator (3, 4) (PVDF-HFP, PEO). The DBP is then extracted by passing the assembly through an ether bath in order to obtain a porous membrane. This porous membrane is then dried and placed inside a glove box of the Jacomex type, for example a Jacomex BS53INMT4 glove box, guaranteeing a moisture content of less 1 ppm, filled with an inert gas (argon) in order for the material once again to be imbibed with a liquid electrolyte. This liquid electrolyte fills the pores left vacant by the plasticizer and gels the PEO. Finally, the membrane (3, 4, 5, 6) thus obtained is deposited on the Li metal negative electrode 2 hot-laminated beforehand onto a copper grid 1 as current collector. It is important to note that the Li/electrolyte interface is formed in situ via the formation of a gel during the contacting of the PEO layer with the liquid electrolyte. The assembly is then hermetically sealed in an aluminum-lined plastic bag (of the “Blue Bag” type from Shield Pack) for electrochemical testing.

It may be noted that the PVDF-HSP/PEO separator (3, 4) can also be manufactured according to the invention in another way, namely:
passing the PVDF-HFP membrane through a PEO acetonitrile solution so as to leave a thin film on the surface or covering the membrane, for example using a brush, with said thin film (see Example 3);
passing the PVDF-HFP membrane through a liquid electrolyte in which a certain quantity of PEO has already been dissolved (see Example 4).

### Example 1

### Slow Cycling of a Battery

A battery comprising an LiV₃O₈-based positive electrode (5, 6), a PVDF-HFP/PEO separator (3, 4), consisting of two layers 3 and 4, and a lithium metal negative electrode (1, 2), mounted under the conditions described above, was galvanostatically cycled between 3.5 and 2 volts at a rate equivalent to the insertion of one lithium ion in 5 hours. The liquid electrolyte used was a mixture of ethylene carbonate and propylene carbonate, in a 1:1 mass ratio, and of a lithium salt known as LiTFSI (lithium trifluoromethanesulfonimide) (in fact the salt LiN(CF₃SO₂)₂ sold under the brand name FLUORAD™ HQ-115 by 3M) in a concentration of 1 mol per liter of solvent. FIG. 3 shows the percentage recovered capacity (C in %) as a function of the number of cycles (N), indicated by curves 7 and 8. Curve 7 is the curve obtained with a battery 10 according to the invention, as shown schematically in FIG. 1. Curve 8 is the curve obtained with a comparative battery 11, as shown schematically in FIG. 2. Comparison between the two curves 7 and 8 shows that the insertion of a gelled PEO layer between the lithium metal anode and the PVDF/HFP-based separator, allows a battery to undergo more than 120 cycles, while maintaining a capacity of more than 80% of its. initial capacity (the end-of-life criterion for industrial batteries).

### Example 2

### Rapid Cycling of a Battery According to Example 1

To approach the industrial requirements in terms of cycling rate, the battery 10 shown in FIG. 1 underwent the following electrochemical test program:
a first cycle comprising a discharge at −0.2 mAh/cm² and a charge at 0.1 mAh/cm²
the other cycles comprise a discharge of the battery in 2 hours (C/2) and a charge in 10 hours (C/10).

In both cases, the limiting voltages were 3.3 V and 2 V.

FIG. 4 shows the percentage recovered capacity (C in %) as a function of the number of cycles (N). Curve 9 is the curve obtained with a battery according to the invention as shown schematically in FIG. 1. During these tests, the technique of operating the battery 10 was the same as in the preceding example.

Despite a high discharge rate, it was found that the battery according to the invention using a PEO layer (the PEO being completely gelled after contacting with the liquid electrolyte) between the lithium and the PVDF/HFP-based separator is capable of recovering more than 80% of its initial capacity after 350 cycles.

### Example 3

### Battery Constructed from a PVDF Membrane Coated with a PEO Solution

In the previous two examples, the PEO was prepared in the form of a layer before being brought into contact with the liquid electrolyte. In the present example, so as advantageously to eliminate one step in the manufacturing process, the PEO was used directly in gel form. To do this, a solvent (typically acetonitrile) was added to the PEO in order to obtain a gel. Such a battery is shown schematically in FIG. 5. A thin layer of this solution was spread, using a brush, over the surface of the lithium. Parallel, the cathode/PVDF-HFP separator assembly was impregnated with liquid electrolyte. All this was assembled to form a battery. Thus, the PEO was used directly in gel form.

### Example 4

### Battery Constructed from a PVDF Membrane Impregnated with a Liquid Electrolyte in Which PEO has Been Dissolved

The same principle, explained in Example 3, may be transposed using the liquid electrolyte EC/PC/LiTFSI (1 mol/l) as solvent for the PEO. In this case, the cathode/PVDF-HFP separator complex was imbibed with the gel. The battery cycling conditions shown were the same as in Example 2. The battery tested is shown schematically in FIG. 5.

The capacity retention is identical to that obtained in batteries using a PEO layer.

FIG. 6 shows the percentage recovered capacity (C in %) with respect to the number N of cycles for a battery 12 as shown in FIG. 5. Curve 18 is the curve obtained with such a battery 12 according to the invention.

It may be seen that the capacity retention is identical to that obtained in the batteries according to the invention using a PEO layer.

1-25. (canceled)

26. A lithium electrochemical cell battery comprising at least one positive electrode, at least one liquid electrolyte comprising at least one lithium salt, and at least one negative electrode, wherein said battery comprises at least one layer of a gelled separator GS comprising at least one polymer GP, able to be gelled by the liquid electrolyte, which is at least partly gelled by the liquid electrolyte, in contact with the negative electrode, and in that it includes at least one layer of a plasticized separator PS comprising at least one polymer PP, able to be plasticized by the liquid electrolyte, which is in contact with the layer of separator GS.

27. The battery according to claim 26, wherein the separator PS layer is at least partly in contact with the positive electrode.

28. The battery according to claim 26, wherein the battery comprises, in addition, another separator GS layer, at least partly between the positive electrode and the separator PS layer.

29. The battery according to claim 26, wherein the polymer PP is selected from the group consisting of polyvinylidene fluoride PVDF, polystyrene PS, polyvinyl chloride PVC, polycarbonate PC, ethylene-propylene-diene monomer EPDM, and derivatives thereof; preferably, the polymer PP is selected from the group consisting of polyvinylidene fluorides PVDFs and (polyvinylidene fluoride)-co-(hexafluoropropylene) PVDF-HFP copolymers, and even more preferably the polymer PP is a PVDF-HFP.

30. The battery according to claim 26, wherein the polymer GP is selected from the group consisting of polymethyl methacrylate PMMA, polyethylene oxide PEO and polyacrylonitrile PAN, and derivatives thereof, preferably, the polymer PG is PEO.

31. The battery according to claim 26, wherein the positive electrode comprises carbon, active material, polymer PP and optionally at least one plasticizer.

32. A process for manufacturing a lithium electrochemical cell battery comprising at least one positive electrode, at least one liquid electrolyte comprising at least one lithium salt, and at least one negative electrode comprising an assembly of at least one layer of gelled separator GS, comprising at least one polymer GP, able to be gelled by the liquid electrolyte, on the negative electrode, of at least one layer of plasticized separator PS, comprising at least one polymer PP, able to be plasticized by the liquid electrolyte, on said separator GS layer, and optionally of at least one other layer of gelled separator GS, comprising at least one polymer GP, on said separator PS layer, the combination of these two or three layers constituting a separator between the negative electrode and the positive electrode, an assembly of said separator on the positive electrode, and an impregnation of said separator by the liquid electrolyte.

33. The process according to claim 32, wherein the positive electrode is manufactured in solution from polymer PP, carbon, active material, plasticizer and solvent.

34. The process according to claim 32, wherein the positive electrode is manufactured by extrusion from polymer PP, carbon, active material and plasticizer.

35. The process according to claim 32, wherein the separator PS layer is manufactured in solution from polymer PP, plasticizer and solvent.

36. The process according to claim 32, wherein the separator PS layer is manufactured by extrusion from polymer PP, plasticizer or liquid electrolyte.

37. The process according to claim 32, wherein the separator GS layer is manufactured in solution from polymer GP, solvent and optionally plasticizer.

38. The process according according to claim 32, wherein the separator GS layer is manufactured by extrusion from polymer GP, and optionally plasticizer or liquid electrolyte.

39. The process according to claim 32, wherein the polymer PP is generally filled with at least one mineral compound selected from the group consisting of MgO, SiO2, Al2O3, TiO2, BaTiO3, LiI and LiAIO2.

40. The process according to claim 32, wherein the polymer GP is generally filled with at least one mineral compound selected from the group consisting of MgO, SiO2, Al2O3, TiO2, BaTiO3, LiI and LiAIO2.

41. The process according to claim 32, wherein the two or three PS and GS layers are joined together into a separator by hot lamination or hot calendering.

42. The process according to claim 32, wherein said layers form a three-layer separator obtained by passing the separator PS layer into a solution of polymer GP, or into a solution of liquid electrolyte in which the polymer GP has been dissolved.

43. The process according to claim 32, wherein said layers form a bilayer separator obtained by passing a separator PS layer (4), preassembled with the positive electrode, into a solution of polymer GP or into a solution of liquid electrolyte in which the polymer GP has been dissolved.

44. The process according to claim 32, wherein the positive electrode and the separator are generally joined together by hot lamination or hot calendering in order to form a plastic complex.

45. The process according to claim 32, wherein the plasticizer(s) optionally present in the positive electrode/separator assembly is (are) removed by washing or vacuum extraction so as to obtain an assembly containing virtually no plasticizer.

46. The process according to claim 32, wherein the separator/positive electrode assembly, preferably containing virtually no plasticizer, is generally brought into contact with the negative electrode by a lamination or calendering step.

47. The process according to claim 32, wherein the plasticizer optionally present is selected from the group consisting of PEO oligomers, dibutyl phthalate (DBP) and propylene carbonate (PC).

48. The process according to claim 32, wherein the polymer PP is selected from the group consisting of polyvinylidene fluoride PVDF and (polyvinylidene fluoride)-co-(hexafluoropropylene) PVDF-HFP; preferably, the polymer PP is PVDF-HFP.

49. The process according to claim 32, wherein the polymer GP is selected from the group consisting of polyethylene oxide PEO and polyacrylonitile PAN, and derivatives thereof, preferably, the polymer GP is PEO.

50. A hybrid vehicle, an electric vehicle, or a stationary or portable equipment including a battery of claim 26.

51. A hybrid vehicle, an electric vehicle, or a stationary or portable equipment including a battery manufactured by the process of claim 32.
